(19) United States
(12) Patent Application Publication
(10) Pub. No.: US 2008/0040550 A1
(43) Pub. Date: Feb. 14, 2008

(54) METHOD AND APPARATUS FOR PROVIDING ENHANCED ACCESS TO A LIGHTWEIGHT DIRECTORY ACCESS PROTOCOL (LDAP) DIRECTORY SERVER

(76) Inventor: David J. LINDNER, Nashua, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/856,180

(22) Filed: Sep. 17, 2007

Related U.S. Application Data
(63) Continuation of application No. 09/611,920, filed on Jul. 7, 2000, now abandoned.

(51) Int. Cl. G06F 12/02

(52) U.S. Cl. 711/130; 711/E12.002

(57) ABSTRACT

The present invention provides for a method and an apparatus for accessing a directory server. The directory server has information stored therein. A caching daemon establishes a first plurality of connections to the directory server. The caching daemon determines if an application is requesting information from the directory server over a second connection between the caching daemon and the application, and determines if the requested information is stored in a data cache within the caching daemon in response to determining that the application has requested information. If the requested information resides within the data cache, the caching daemon forwards the requested information to the application over the second connection. If the requested information is not present within the data cache, the caching daemon accesses the requested information from the directory server over one of the first plurality of connections. Upon receiving the requested information from the directory server, the caching daemon sends the requested information to the application over the second connection.

### CROSS REFERENCE TO RELATED APPLICATION

This application is a continuation of application Ser. No. 09/611,920, filed Jul. 7, 2000, entitled “Method and Apparatus for Providing Enhanced Access to a Lightweight Directory Access Protocol (LDAP) Directory Server,” and which application is incorporated by reference herein as if reproduced in full below.

### BACKGROUND OF THE INVENTION

1. Field of the Invention

This invention relates generally to directory server access in computer systems, and, more particularly, to a method and apparatus for directory server access using a lightweight directory access protocol (LDAP) caching daemon.

2. Description of the Related Art

Lightweight Directory Access Protocol (LDAP) is an industry-standard software protocol that enables a person to locate organizations, individuals, as well as other resources such as files and devices, for example, within a network. The network may be the Internet, for example, or on a smaller scale, the network may be a corporate intranet. LDAP is essentially a “lightweight” version of Directory Access Protocol (DAP), which is part of X.500, a standard for directory services in a network. An advantage of LDAP is that it runs directly over Transmission Control Protocol/Internet Protocol (TCP/IP) and provides most of the functionality of DAP, however, at a much lower cost.

A directory provides information as to the location of a particular thing within the network. For example, on TCP/IP networks, which include the Internet, the Domain Name System (DNS) is the directory system used to relate the domain name to a specific network address (i.e., a unique location in the network). LDAP allows a person to search for an individual, for example, without knowing the domain name or where that individual may be located within the network.

An LDAP directory is organized in a hierarchical tree-like structure that typically reflects political, geographical and/or organizational boundaries. For example, the directory may include countries at the top of the tree. These countries may then branch out into organizations, which may extend to organizational units, such as divisions, departments, etc., and then onto individuals, such as people, files, documents and shared resources such as printers, for example.

An LDAP directory may be distributed among many servers, where each server may have a replicated version of the entire LDAP directory. An LDAP directory server, also commonly known as a Directory System Agent (DSA), typically receives a request for information from the LDAP directory from a client server that is running a particular application.

Turning now to the drawings, and specifically referring to FIG. 1, a system 100 for providing LDAP directory server access to a plurality of client server applications is shown in accordance with the prior art. Typically, when a client server application 120 desires to access data from a directory server 110, the application 120 establishes a direct connection 125 to the directory server 110 through a binding operation. The function of the binding operation is to initiate a protocol session between a client and the directory server 110, and to allow authentication of the client to the server 110. The client server application 120 establishes the connection 125 to the server 110 via a bind request. Upon receiving the bind request from the client server application 120, the directory server 110 will authenticate the requesting client if necessary, and attempt to set up a protocol session with the client. The directory server 110 subsequently sends a bind response to the client server application 120, thereby providing an indication of the status of the session startup request. Upon successfully establishing the connection 125 with the directory server 110, the application 120 then retrieves the desired data from the directory server 110 by performing a search operation. After retrieving this desired data, the client server application 120 may then perform an unbind operation to terminate the protocol session between the client server application 120 and the directory server 110. Subsequent to receiving the unbind request, the directory server 110 closes the connection 125 with the client server application 120.

A drawback currently encountered in LDAP, however, is that it requires each client to bind directly to the directory server 110 before being able to perform a request for information from the LDAP directory. That is, the client server applications 120 running on the OS establish a direct connection to the directory server 110, thereby placing a substantial load on the directory server 110 by engaging individual connections with each application 120. As a result of this additional load, the directory server 110 suffers substantial degradation in performance for data retrieval.

The present invention is directed to overcoming, or at least reducing the effects of, one or more of the problems set forth above.

### SUMMARY OF THE INVENTION

In one aspect of the present invention, a method is provided for accessing a directory server. The method includes establishing a first plurality of connections between the directory server and a caching daemon. It is determined if an application is requesting information from the directory server. In response to determining that the application has requested information, it is determined if the requested information is stored in the caching daemon. The requested information is then sent to the application.

In another aspect of the present invention, an apparatus is provided. The apparatus comprises a directory server for storing information and a caching daemon. The caching daemon being adapted to establish a first plurality of connections to the directory server and determine if an application is requesting information from the directory server. The caching daemon is further adapted to determine if the requested information is stored within the caching daemon and to send the requested information to the application.

### BRIEF DESCRIPTION OF THE DRAWINGS

The invention may be understood by reference to the following description taken in conjunction with the accompanying drawings and appendices, in which like reference numerals identify like elements, and in which:

FIG. 1 is a simplified diagram illustrating the access of a directory server by a plurality of client server applications according to the prior art;

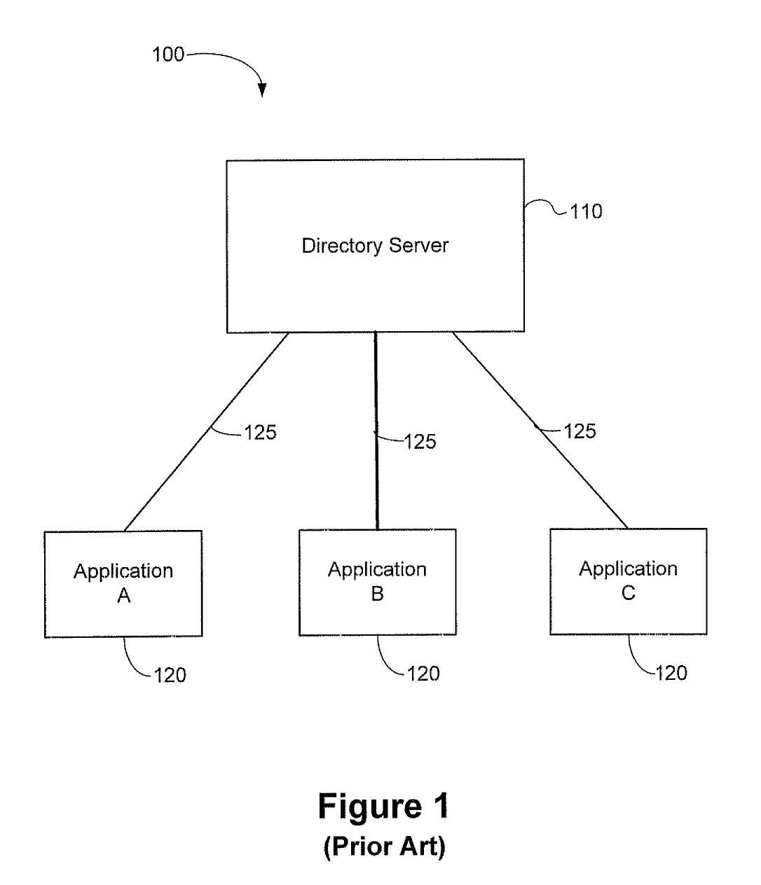

FIG. 2 illustrates a simplified diagram for providing access to the directory server from the plurality of client server applications via a Lightweight Directory Access Protocol (LDAP) caching daemon according to one embodiment of the present invention;

FIG. 3 provides a more detailed representation of the LDAP caching daemon provided in FIG. 2; and

FIG. 4 illustrates a process for facilitating directory server access by the plurality of client server applications in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

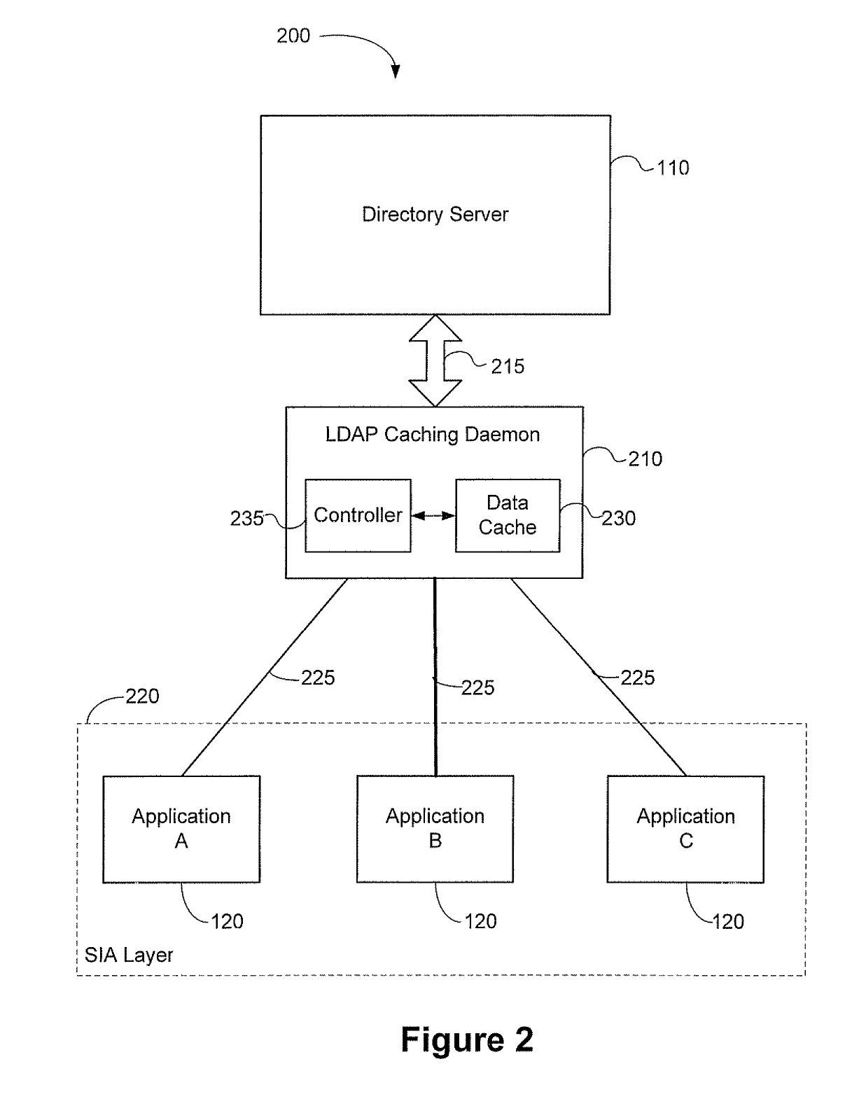

Referring back to the drawings, and specifically to that of FIG. 2, a system 200 for facilitating access to a directory server 110 from a plurality of applications 120 running on an operating system (OS) is provided. In accordance with the illustrated embodiment, the applications 120 are generated by a plurality of client servers (not shown). According to one embodiment of the present invention, the directory server 110 operates in accordance with a Lightweight Directory Access Protocol (LDAP), which is an industry-standard network protocol for directory server access. It will be appreciated, however, that the directory server 110 may also operate according to various other industry-standard network protocols, such as Directory Access Protocol (DAP), for example, without departing from the spirit and scope of the present invention.

As previously discussed, the client server applications 120 running on the OS typically establish a direct connection to the directory server 110, thereby placing a substantial load on the directory server 110 by engaging individual connections with each application 120. As a result of this additional load, the directory server 110 suffers substantial degradation in performance for data retrieval. To alleviate the burden on the directory server 110, an LDAP caching daemon 210 is provided for connection to the directory server 110 in accordance with one embodiment of the present invention. In the illustrated embodiment, the LDAP caching daemon 210 is a multi-threaded Internet UNIX daemon, and accesses data from the directory server 110 via a plurality of connections represented at 215. The number of connections at 215 may be configurable to facilitate the retrieval of data from the directory server 110 by the caching daemon 210. Furthermore, in addition to being coupled to the one directory server 110 provided in FIG. 2, it will be appreciated that the caching daemon 210 may also couple to multiple directory servers 110 without departing from the spirit and scope of the present invention. Only one directory server 110, however, is depicted in FIG. 2 for simplicity sake in illustrating the present invention. The LDAP directory server(s) 110 access data from an LDAP directory (not shown).

In accordance with the illustrated embodiment, the LDAP caching daemon 210 resides between the directory server 110 and a Security Integration Architecture (SIA) layer 220 of the OS. The plurality of client server applications 120 that run in the SIA layer 220 of the OS send data requests that are intended for the directory server 110 to the LDAP caching daemon 210. These applications 120 in the SIA layer 220 may include, file transfer protocol (ftp), telnet, rlogin, and CDE, for example. It will be appreciated, however, that the applications 120 may include various other application types running on the client server, and, thus, need not necessarily be limited to the aforementioned examples. Furthermore, the number of applications 120 that are able to access the caching daemon 210 may vary depending on system requirements.

In one embodiment of the present invention, the connections 215 established between the directory server 110 and the caching daemon 210 run continuously awaiting for a connection 225 to be established between the client server applications 120 in the SIA layer 220 and the caching daemon 210. When a connection 225 is established between the application 120 and the caching daemon 210, a thread is created to handle the connection 225. Depending upon the operation being performed by the client server application 120, the thread may persist to perform multiple operations on behalf of the SIA layer 220, or may terminate upon completing a single operation by the application 120. It will be appreciated that the establishment of the thread may be performed by the “boss/worker” model, for example, where the “boss” listens for the connection 225 between the application 120 and the caching daemon 210 and then creates the thread once the connection 225 is established. Establishing threads in accordance with the “boss/worker” model is well know to those of ordinary skill in the art. Accordingly, the specifics for establishing the threads will not be discussed herein to avoid unnecessarily obscuring the present invention.

According to one embodiment of the present invention, the caching daemon 210 operates transparently from the perspective of the client server applications 120 that desire to access data from the directory server 110. To integrate the caching daemon 210 into the OS upon which these applications 120 are running, the SIA layer 220 is used to create a shared library with a predefined set of Application Programming Interfaces (APIs). The APIs correspond to the required set of security APIs that are used by the OS. By creating this shared library, it causes all of the existing libc security APIs to resolve to the new library. Accordingly, by using the SIA layer 220, all of the “security aware” applications 120 running on the OS will directly access the caching daemon 210 in a transparent manner, i.e., the client server applications 120 will not realize they are accessing the caching daemon 210, but rather will believe they are accessing the directory server 110 directly.

According to one embodiment of the present invention, the LDAP caching daemon 210 comprises a data cache 230, which is configured to store data that is retrieved from the directory server 100. When the application 120 binds to the caching daemon 210 and sends a data request over the connection 225, a controller 215 within the caching daemon 210 determines whether the requested data by the application 120 has been previously stored in the data cache 230. If the requested data has been previously cached, the controller 215 retrieves the requested data from the data cache 230 and sends this data to the requesting application 120 in the SIA layer 220 via connection 225.

If, however, the requested data has not been previously stored in the data cache 230, then the controller 215 sends a request for the data to the directory server 110 via one of the plurality of connections established at 215. Once retrieved, the requested data is stored in the data cache 230 for any subsequent retrieval for a future request by another application 120 for the same data. The controller 215 of the caching daemon 210 then forwards the retrieved data from the directory server 110 to the requesting application 120 via the connection 225.

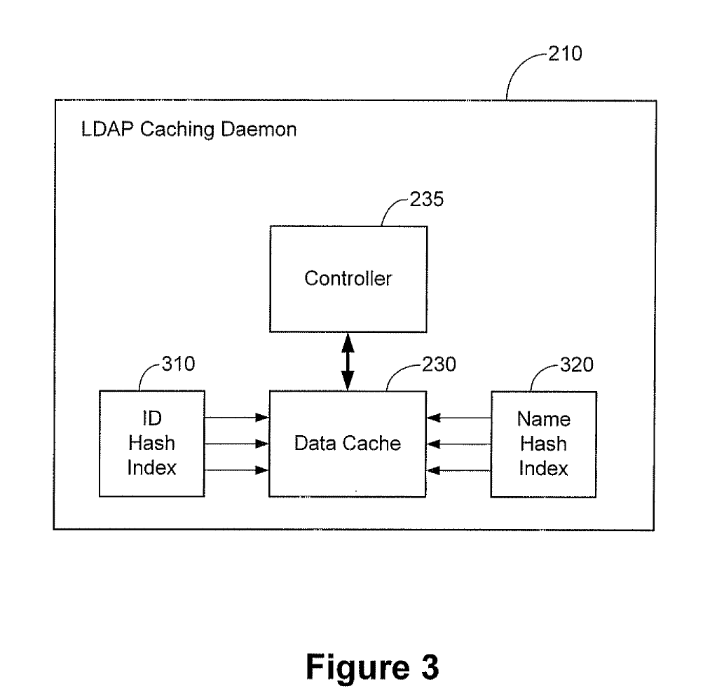

In accordance with one embodiment, the data cache 230 is indexed via two separate indexes, an ID hash index 310 and a name hash index 320 as shown in FIG. 3. Accordingly, the information/data that is retrieved from the directory is stored once in the data cache 230, with multiple indexes into the stored data via the ID hash and name hash indexes 310, 320. According to one embodiment, the name hash index 320 is a hash table that points to data entries in the data cache 230 whether these entries consist of group names or user names. Similarly, the ID hash index 310 is a hash table that points to entries in the data cache 230 whether the entries are user IDs or group IDs.

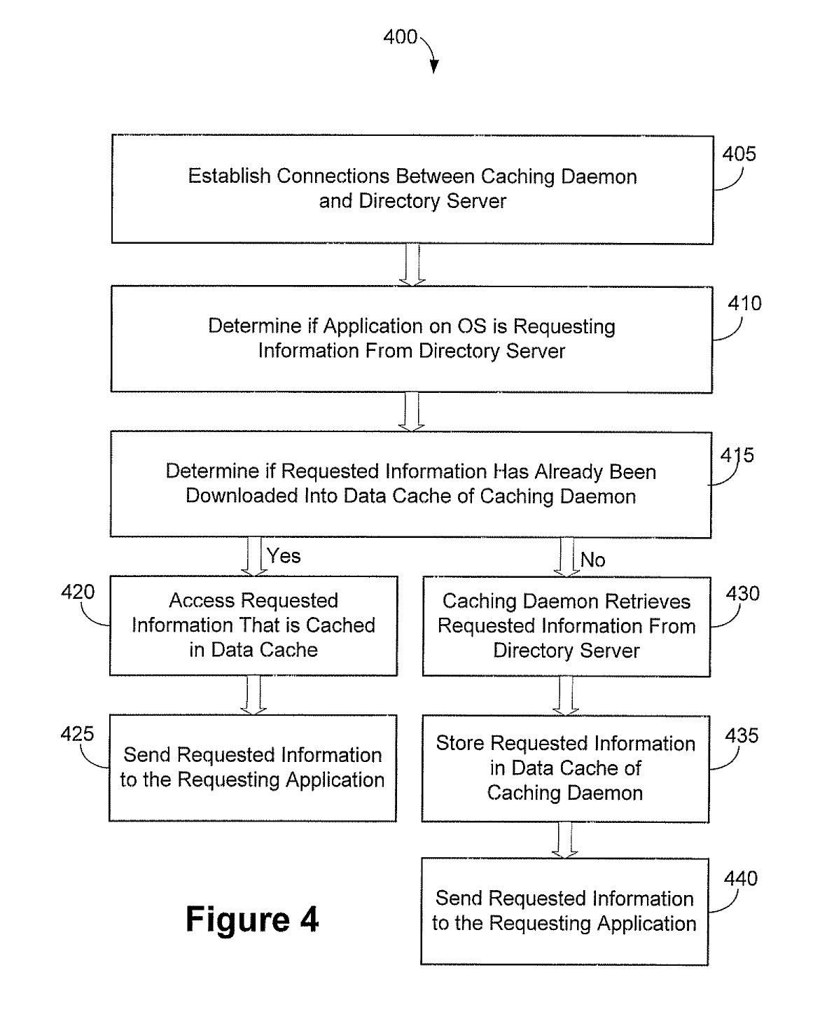

Turning now to FIG. 4, a process 400 for facilitating access to the directory server 110 by a plurality of applications 120 running on the SIA layer 220 of the OS is provided. The process 400 commences at block 405 where the LDAP caching daemon 210 establishes a pool of connections 215 with the directory server 110. In accordance with one embodiment, the number of connections 215 established between the caching daemon 210 and the directory server 110 may be set by a parameter within the configuration file running on the OS. According to the illustrated embodiment, these connections 215 run continuously between the caching daemon 210 and the directory server 110, and awaits any data requests that are initiated by the application 120.

At block 410, the caching daemon 210 determines whether any of the applications 120 running on the OS are requesting information retrieval from the directory server 110. If any of these applications 120 are requesting information retrieval from the directory server 110, the caching daemon 210 determines at block 415 whether the information being requested by the application 120 has previously been downloaded into the data cache 230 of the caching daemon 210 from a previous request. If the information being requested by the application 120 has already been cached in the data cache 230 from the directory server 110, the caching daemon 210 accesses the previously cached information at block 420, and sends the information to the requesting application 120 at block 425 via the connection 225.

If the information being requested by the application 120 has not already been cached in the data cache 230 from a previous request, the caching daemon 210, via one of the plurality of connections 215, accesses the directory server 110 to retrieve the desired information at block 430. Upon downloading the requested information from the directory server 110, the caching daemon 210 stores the requested information in the data cache 230 at block 435 for any subsequent requests for the same information. At block 440, the caching daemon 210 sends the requested information to the application 120 that initially requested the data via the established connection 225.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method comprising:
simultaneously and continuously maintaining a first plurality of connections between a first Lightweight Directory Access Protocol (LDAP) server and a caching daemon;
receiving from an application a request for information from an LDAP server, the receiving by the caching daemon;
obtaining the requested information by the caching daemon from at least one selected from the group consisting of: the first LDAP server over at least one of the first plurality of connections; and data previously requested and stored by the caching daemon; and
sending the requested information to the application.

2-4. (canceled)

5. The method of claim 1, further comprising:
storing the information retrieved from the first LDAP server at the caching daemon.

6-15. (canceled)

16. A computer-readable medium that stores a caching daemon that, when executed by a processor, causes the processor to:
implement a data cache that store a subset of information from one or more directory servers;
establish and continuously maintain a first plurality of connections to a first directory server;
receive from an application a request for information stored in a directory server;
obtain the requested information from at least one selected from the group consisting of: the first directory server over at least one of the first plurality of connections; and the data cache; and
send the requested information to the application.

17. The computer-readable medium according to claim 16 wherein the caching demon, when executed by the processor, further causes the processor to establish a connection to the application and receive a request for information from the application over the connection.

18-19. (canceled)

20. The computer-readable medium according to claim 16 wherein the caching daemon, when executed by the processor, further causes the processor to store the information retrieved from the first directory server at the data cache.

21. The method of claim 1 further comprising:
simultaneously and continuously maintaining a second plurality of connections between a second LDAP server and the caching daemon;
wherein obtaining further comprises obtaining the requested information by the caching daemon from at least one selected from the group consisting of: the first LDAP server over at least one of the first plurality of connections; the second LDAP server over at least one of the second plurality of connections; and data previously requested and stored by the caching daemon.

22. The computer-readable medium according to claim 16 wherein the caching daemon, when executed by the processor, further causes the processor to:
establish and continuously maintain a second plurality of connections to a second directory server;
obtain the requested information from at least one selected from the group consisting of: the first director server over at least one of the first plurality of connections; the second director server over at least one of the second plurality of connections; and the data cache.
